(19) United States
(12) Patent Application Publication
(10) Pub. No.: US 2013/0140923 A1
(43) Pub. Date: Jun. 6, 2013

(54) ELECTRIC MACHINE COOLING STRUCTURE

(71) Applicants: Edward L. Kaiser, Orion, MI (US); Peter Bostwick, Rochester, MI (US)

(72) Inventors: Edward L. Kaiser, Orion, MI (US); Peter Bostwick, Rochester, MI (US)

(73) Assignee: GM GLOBAL TECHNOLOGY OPERATIONS LLC, Detroit, MI (US)

(21) Appl. No.: 13/425,798

(22) Filed: Mar. 21, 2012

Related U.S. Application Data
(60) Provisional application No. 61/567,087, filed on Dec. 5, 2011.

(51) Int. Cl. H02K 9/19

(52) U.S. Cl. 310/54

(57) ABSTRACT

A housing surrounding a stator or a rotor includes an annular cooling chamber, which is formed within the housing and defines a circumferential fluid path around the stator or rotor. A fluid inlet and a fluid outlet are communication with the annular cooling chamber. A primary divider separates the fluid inlet from the fluid outlet.

### CROSS-REFERENCE TO RELATED APPLICATIONS

This application claims the benefit of U.S. Provisional Patent Application No. 61/567,087, filed on Dec. 5, 2011, the disclosure of which is hereby incorporated by reference.

### TECHNICAL FIELD

This disclosure relates to structures for cooling the components, such as rotor or stators, of electric machines.

### BACKGROUND

A stator is the stationary part of an electric machine. The stator interacts with a rotor, which is the moving or rotating part of the electric machine. The stator and rotor allow the electric machine to convert mechanical energy to electrical energy (generator mode) and to convert electrical energy to mechanical energy (motor mode).

### SUMMARY

A housing surrounding at least one of a stator and a rotor for an electric machine is provided. An annular cooling chamber is formed within the housing and defines a circumferential fluid path around the stator or rotor. A fluid inlet and a fluid outlet are in communication with the annular cooling chamber. A primary divider separates the fluid inlet from the fluid outlet.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, isometric view of an electric machine, partially illustrating some of the internal features;

FIG. 2 is a schematic, plane-intersection view of the electric machine shown in FIG. 1, taken along a section or plane line 2-2;

FIG. 3 is a schematic, isometric view of a housing for the electric machine shown in FIG. 1, shown with a cover member removed and a plurality of baffles before insertion into an annular cooling chamber;

FIG. 4 is a schematic, plan view of the housing shown in FIG. 3 with the baffles inserted; and

FIG. 5 is a schematic, enlarged view of a portion of the housing and one of the baffles.

### DETAILED DESCRIPTION

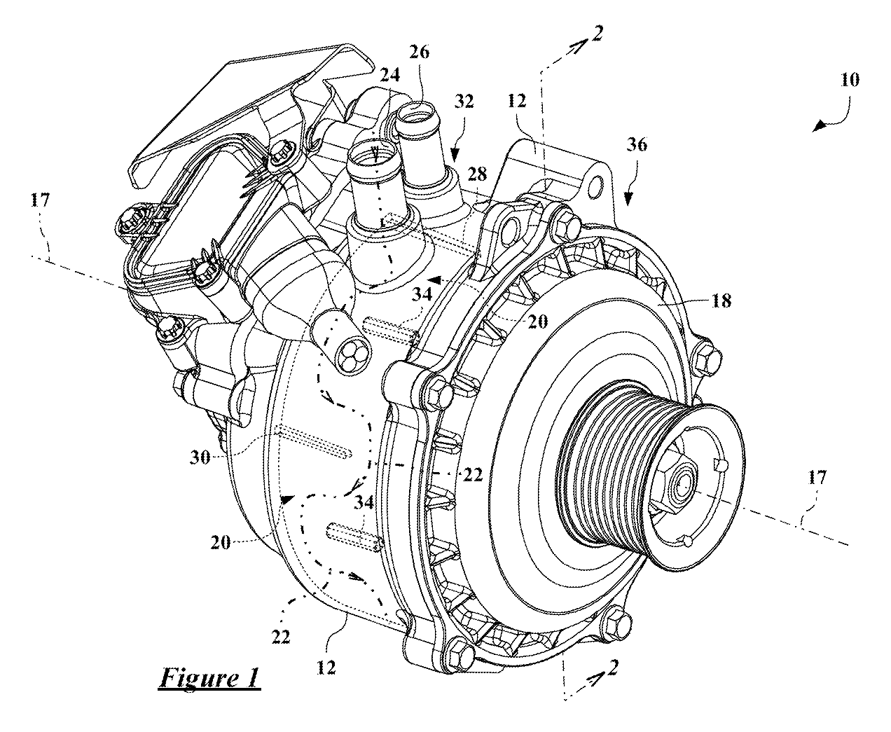

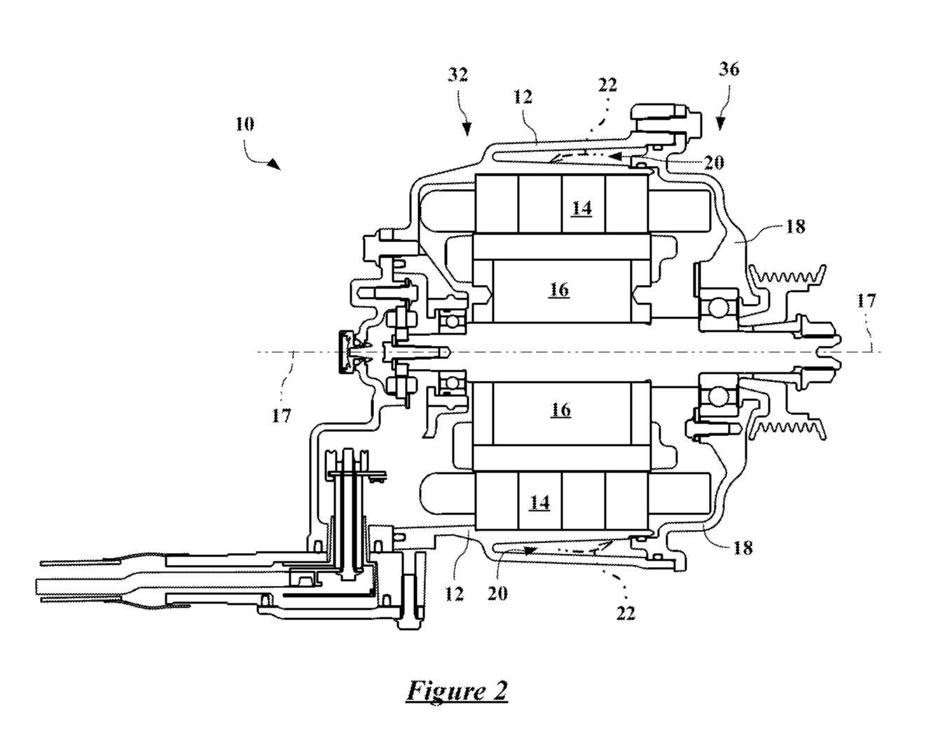

Referring to the drawings, wherein like reference numbers correspond to like or similar components whenever possible throughout the several figures, there are shown in FIG. 1 and FIG. 2 two schematic views of an electric machine 10. FIG. 1 shows an isometric view of the electric machine 10, substantially assembled. FIG. 2 shows a plane intersection of the electric machine 10, taken along a line 2-2 of FIG. 1. Features and components shown in other figures may be incorporated and used with those shown in FIG. 1 and FIG. 2, and components may be mixed and matched between any of the configurations shown.

The electric machine 10 has a housing 12 surrounding numerous internal components. The internal components of the electric machine 10 include at least one of a stator 14 and rotor 16, which rotates about an axis 17. The stator 14 and rotor 16 are generally only viewable in FIG. 2.

A cover member 18 attaches to, or mates with, the housing 12. The axis 17 may be used to define an axial direction or axial movement that occurs generally along or parallel to the axis 17. A corresponding radial direction occurs moving outward or inward from the axis 17.

While the present invention may be described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The housing 12 and the cover member 18 form and define an annular cooling chamber 20, which is partially illustrated in FIG. 1 with dashed lines and is partially viewable in FIG. 2 intersecting the view plane. The annular cooling chamber 20 is an open area between portions of the housing 12. The annular cooling chamber 20, along with other structures discussed herein, define a circumferential fluid path 22 around the stator 14. The circumferential fluid path 22 is illustrated in FIG. 1 by a dashed, serpentine pathway. The cover member 18 may include o-rings or other sealing features to help prevent loss of fluid from the annular cooling chamber 20.

As shown in FIG. 1, a fluid inlet 24 is in communication with the annular cooling chamber 20, and a fluid outlet 26 is in communication with the annular cooling chamber 20. A primary divider 28 separates the fluid inlet 24 from the fluid outlet 26. The primary divider 28 spans substantially the full axial length of the annular cooling chamber 20, and substantially prevents cross flow of fluid between the fluid inlet 24 and the fluid outlet 26.

The electric machine 10 shown in the figures includes only a single annular cooling chamber 20 fed by one fluid inlet 24 and one fluid outlet 26. However, some configurations of the electric machine 10 may define two separate annular cooling chambers 20 in the housing 12. In such a configuration, the housing 12 may include multiple pairs of fluid inlets 24 and fluid outlets 26. Additional cooling routing and chamber configurations may also be used.

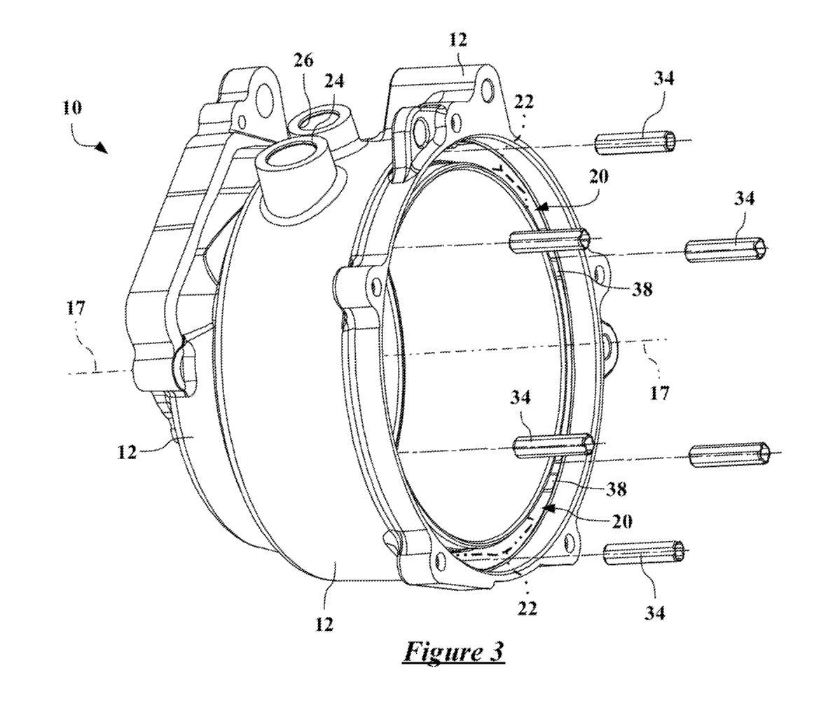

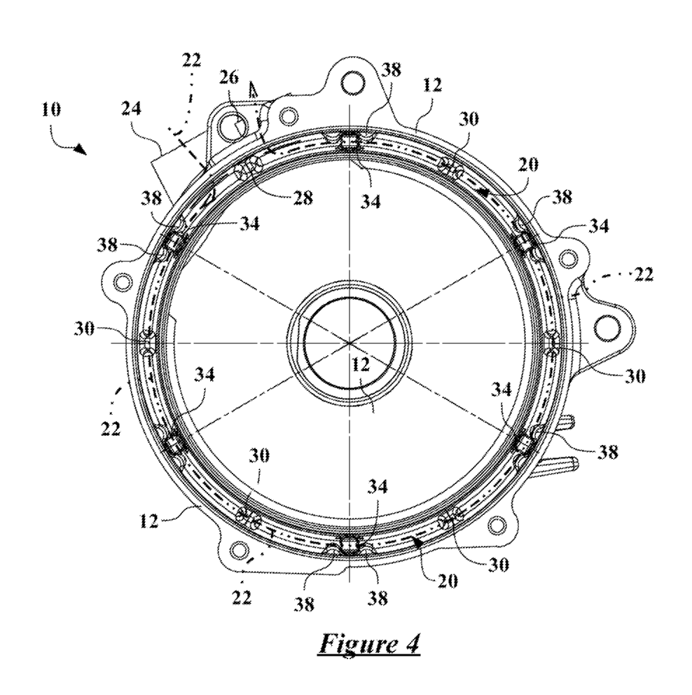

Referring now to FIG. 3 and FIG. 4, and with continued reference to FIGS. 1 and 2, there are shown additional views of portions of the electric machine 10. FIG. 3 shows an isometric view of the housing 12 without the cover member 18 attached thereto, and FIG. 4 shows a plan view of the housing 12.

The annular cooling chamber 20 could be completely open, such that fluid flows in a ring-shaped path from the fluid inlet 24 to the fluid outlet 26. However, the housing 12 of is designed with structure to create the serpentine route of the circumferential fluid path 22 within the annular cooling chamber 20. As viewed in FIG. 2, the circumferential fluid path 22 comes out of the top portion of the annular cooling chamber 20 and flows into the bottom portion of the annular cooling chamber 20. Some portions of the illustrative circumferential fluid path 22 may be viewable in FIG. 3, although the annular cooling chamber 20 and the circumferential fluid path 22 would be blocked from view by the cover member 18.

A plurality of first partial dividers or ribs 30 are placed to intermittently obstruct flow on a first axial side 32 of the annular cooling chamber 20. Additionally, a plurality of second partial dividers or baffles 34 are placed to intermittently obstruct flow on a second axial side 36 of the annular cooling chamber 20.

The ribs 30 and the baffles 34 are staged on opposite sides of the annular cooling chamber 20, such that the circumferential fluid path 22 has the serpentine path. In the housing 12 shown, there are six baffles 34 and six as-cast divider (five ribs 30 and the primary divider 28). However, the ribs 30 and the baffles 34 need not be staggered in exactly equal proportion or with equal distances therebetween. The number of the ribs 30 and the baffles 34 is selected to give the best balance between cooling capability and pressure drop caused by diverting fluid flow. The circumferential fluid path 22 is again schematically illustrated in FIG. 4 and would be behind (relative to the viewer) the baffles 34 and in front of the ribs 30.

In the housing 12, the ribs 30 are formed as continuous, one-piece portions of the housing 12, and are formed from the same material. The baffles 34 are not formed as continuous, one-piece portions of the housing 12, but are placed or inserted into the second axial side 36 of the annular cooling chamber 20. For example, and without limitation, the baffles 34 may be extruded flexible plastic tubes. Therefore, the baffles may be configured to flex against imperfections or manufacturing tolerances of the annular cooling chamber 20 formed during casting of the housing 12.

The housing 12 may be formed as a casting with the annular cooling chamber 20 formed therein through the casting process. Furthermore, the ribs 30 may be as-cast features—directly formed during casting—of the housing 12. The casting process for the housing 12 is likely to impart one or more draft angles to the annular cooling chamber 20. The baffles 34 are flexible, such that they are capable of adjusting to the changing gap creating by the draft angle and by manufacturing variability.

When the ribs 30 are as-cast structures, the ribs 30 may also provide structural support for the housing 12. Therefore, the circumferential fluid path 22 is structurally defined by both as-cast features (the plurality of ribs 30) and insertable features (the plurality of baffles 34 that are inserted into the annular cooling chamber 20).

The housing 12 includes a plurality of baffle guides 38 formed on the second axial side 36 of, and extending partially into, the annular cooling chamber 20. The baffle guides 38 may be cast as continuous portions of the housing 12 and are placed in pairs around the annular cooling chamber 20. Pairs of the baffle guides 38 form pockets into which the baffles 34 may be inserted. After assembly, each of the baffles 34 is disposed in a pocket between a pair of the baffle guides 38. The baffles 34 are configured to flex and conform to the pockets, any imperfections in the housing 12, and any draft angle from casting the housing 12.

As cooling fluid, such as automatic transmission fluid, water, or water ethylene glycol mixture, moves from the fluid inlet 24 to the fluid outlet 26, it serpentines through the circumferential fluid path 22 in the annular cooling chamber 20. The ribs 30 and the baffles 34 add distance to the circumferential fluid path 22 traveled by the cooling fluid. The fluid absorbs heat energy and carries it away from the electric machine 10. The primary divider 28 separates the fluid inlet 24 from the fluid outlet 26 to prevent cross-flow and prevent the cooling fluid from taking more than one lap through the circumferential fluid path 22.

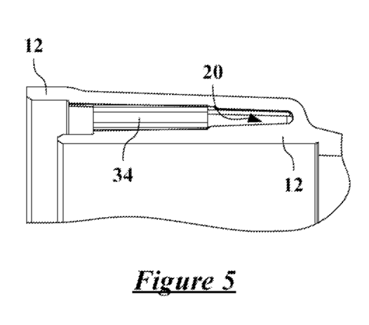

Referring now to FIG. 5, and with continued reference to FIGS. 1-4, there is shown an enlarged view of a portion of the housing 12. The view shown in FIG. 5 illustrates one of the baffles 34 inserted into the annular cooling chamber 20. The housing 12 is formed with two different draft angles to help create the pocket into which the baffles 34 are inserted. Therefore, the baffles 34 insert up to the change in the draft angle, which restrains further movement into the annular cooling chamber 20.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A housing surrounding at least one of a stator and rotor, comprising:
an annular cooling chamber formed within the housing and defining a circumferential fluid path, through which a cooling fluid may move;
a fluid inlet in communication with the annular cooling chamber;
a fluid outlet in communication with the annular cooling chamber; and
a primary divider separating the fluid inlet from the fluid outlet, such that cooling fluid entering the fluid outlet passes through the circumferential fluid path and exits the fluid outlet.

2. The housing of claim 1, further comprising a plurality of first partial dividers intermittently obstructing flow on a first axial side of the annular cooling chamber.

3. The housing of claim 2, further comprising a plurality of second partial dividers intermittently obstructing flow on a second axial side of the annular cooling chamber and offset from the first partial dividers, such that the circumferential fluid path serpentines around the first partial dividers and the second partial dividers.

4. The housing of claim 3, wherein the first partial dividers are formed as continuous, one-piece portions of the housing.

5. The housing of claim 4, further comprising a plurality of baffles, wherein the baffles are placed on the second axial side of the annular cooling chamber and act as the second partial dividers.

6. The housing of claim 5, further comprising a cover member configured to cooperate with the annular cooling chamber to define the circumferential fluid path.

7. The housing of claim 6, wherein the housing is a casting and the annular cooling chamber and the first partial dividers are as-cast structures of the housing.

8. The housing of claim 7, further comprising a plurality of baffle guides formed on the second axial side of the housing and extending partially into the annular cooling chamber, wherein the baffles are disposed between pairs of the baffle guides.

9. The housing of claim 8, wherein the baffles are flexible tubes.

10. A housing surrounding at least one of a stator and rotor, comprising:
an annular cooling chamber formed within the housing and defining a circumferential fluid path, through which a cooling fluid may move;
a fluid inlet in communication with the annular cooling chamber;
a fluid outlet in communication with the annular cooling chamber;
a primary divider separating the fluid inlet from the fluid outlet, such that cooling fluid entering the fluid outlet passes through the circumferential fluid path and exits the fluid outlet;
a plurality of partial dividers intermittently obstructing flow on a first axial side of the annular cooling chamber; and
a plurality of baffles intermittently obstructing flow on a second axial side of the annular cooling chamber and offset from the partial dividers, such that the circumferential fluid path serpentines around the partial dividers and the baffles.

11. The housing of claim 10, further comprising a plurality of baffle guides formed on the second axial side of the housing and extending partially into the annular cooling chamber, wherein the baffles are disposed between pairs of the baffle guides.

12. The housing of claim 11, wherein the baffles are flexible tubes.

13. The housing of claim 12, wherein the housing is a casting and the annular cooling chamber and the partial dividers are as-cast structures of the housing.
